(19) United States
(12) Patent Application Publication
(10) Pub. No.: US 2020/0296119 A1
(43) Pub. Date: Sep. 17, 2020

(54) APPARATUS AND METHOD FOR SECURITY CONTROL

(71) Applicant: ELECTRONICS AND TELECOMMUNICATIONS RESEARCH INSTITUTE, Daejeon (KR)

(72) Inventors: Jae Deok LIM, Sejong-si (KR); Kyeong Tae KIM, Daejeon (KR); Jeong Nyeo KIM, Daejeon (KR); Seon Gyoung SOHN, Daejeon (KR); Yun Kyung LEE, Daejeon (KR)

(21) Appl. No.: 16/813,986

(22) Filed: Mar. 10, 2020

(30) Foreign Application Priority Data
Mar. 11, 2019 (KR) 10-2019-0027801
Mar. 26, 2019 (KR) 10-2019-0034594

(51) Int. Cl. H04L 29/06

(52) U.S. Cl. CPC H04L 63/1416; H04L 63/20

(57) ABSTRACT

Provided is an apparatus and method for security control that is capable of preventing a security threat from spreading on the basis of a security control policy established for each device (or a device group) in a network infrastructure environment, such as IoT. In a network infrastructure including a service server, a gateway, and a device, the apparatus and method for security control, in response to detecting a security threat, such as distributed denial of service (DDoS) attacks, malicious code propagation, or the like, perform a security control and a security control release on a device in which the security threat has occurred and/or a device group having an identical or similar property to the device to prevent the security threat from spreading and block the security threat in an early stage.

### CROSS-REFERENCE TO RELATED APPLICATIONS

This application claims priority to and the benefit of Korean Patent Applications, No. 10-2019-0027801 filed on Mar. 11, 2019 and No. 10-2019-0034594 filed on Mar. 26, 2019, the disclosures of which are incorporated herein by reference in its entirety.

### BACKGROUND

### 1. Field of the Invention

The present invention relates to a technology of security control, and more specifically, to an apparatus and method for security control that may prevent distributed denial of service (DDoS) attacks, malicious codes, and other security threats to a network infrastructure, such as an Internet of Things (IoT) network, from spreading and may block such security threats at an early stage.

### 2. Description of Related Art

Network segmentation is an existing technology for preventing proliferation of intrusion into a network. The basic concept of the technology is to segment management areas in units of network flows (e.g., services, etc.) and apply an access control policy to accessing between the segmented areas of network flows, so that illegal access between network flows is controlled.

However, the technology may block illegal accessing that violates an access policy between previously segmented areas of network flows but does not prevent the spread of intrusion occurring in the connections between multiple clients and service servers connected in a workflow area. That is, when a security threat occurs within a network flow area, the security threat is not prevented from spreading in the network flow area. In addition, the technology may not prevent a security threat from spreading into a network flow area that is set to be allowed for accessing by an access control policy.

Moreover, the network segmentation is basically applied more to east-west traffic in a server-to-server connection environment rather than north-south traffic in a client-to-server connection environment in a cloud where a data center (i.e., server groups) operates and thus has a limitation in preventing a security threat from spreading in a network infrastructure of a device-gateway-server structure (e.g., IoT). In particular, a security threat in an IoT environment may cause the things connected to Internet to become a source of information leak or malfunction or become a disseminator of extensively spreading malicious codes and spams, thereby the extent of damage being expected to be very large.

Since most threats to devices in IoT or other networks are mostly executed by intruding in the network through a vulnerable module of a device and then approaching a primary module, it is important to ensure the security of a device operating environment and prevent a threat to each function in the device from spreading. However, the existing security technologies for network security enhancement operate as fragmentary applications that only remove individual security threats. Accordingly, there is a need for a technology which controls the spread of a security threat, which penetrates into the network infrastructure, from spreading to the entire infrastructure to minimize the damage to services. In addition, even after performing a security control on the network to process the security threat, the service needs to be seamlessly provided. Accordingly, a network security control release function also needs to be provided at a level where the service delay is minimized through rapid resumption of the service.

### SUMMARY OF THE INVENTION

The present invention provides an apparatus and method for security control that is capable of performing blocking and blocking-release using a security control policy with respect to a security threat penetrated into a network infrastructure, such as Internet of Things (IoT), from spreading to the entire infrastructure.

The technical objectives of the present invention are not limited to the above, and other objectives may become apparent to those of ordinary skill in the art based on the following description.

According to one aspect of the present invention, there is provided an apparatus for security control in a network infrastructure including one or more devices, the apparatus including: a storage configured to store device information and a standard security control policy generated with regard to a potential security threat; and a processor, wherein the processor is configured to operate: a security control policy determiner configured to determine a policy of security control on the device in which a security threat is expected; and a security control policy distributor configured to generate a security control message on the basis of the determined policy of security control and transmit the generated security control message to the device in which the security threat is expected.

In one embodiment, the device in which the security threat is expected may belong to a device group.

The processor may be configured to operate a device manager that monitors a security control status for the security threat to the at least one device.

The processor may be further configured to operate a security control policy manager that generates the standard security control policy for the potential security threat.

According to another aspect of the present invention, there is provided a method for security control in a network infrastructure including one or more devices, the method including: determining a policy of security control on the device in which a security threat is expected; and generating a security control message on the basis of the determined policy of security control and transmitting the generated security control message to the device in which the security threat is expected.

The method may further include monitoring a security control status for the security threat to the at least one device.

The method may further include generating a security control release message on the basis of the policy of security control.

Hereinafter, the above described concepts of the present invention will become readily apparent with reference to descriptions of the following detailed embodiments when considered in conjunction with the accompanying drawings.

### BRIEF DESCRIPTION OF THE DRAWINGS

FIG. 1 schematically illustrates a system for security control for an Internet of Things (IoT) infrastructure according to an embodiment of the present invention.

FIG. 2 is a block diagram illustrating a security control server shown in FIG. 1.

FIG. 3 is a flowchart showing a method of network security control according to an embodiment of the present invention.

FIG. 4 is a flowchart showing a process of performing network security control by the apparatus for security control shown in FIG. 2 according to the security control process shown in FIG. 3.

FIG. 5 is a flowchart showing a process of performing network security control release according to the security control process shown in FIG. 3 by the apparatus for security control shown in FIG. 2.

FIG. 6 is an exemplary flowchart showing a network connection blocking procedure in an IoT infrastructure.

FIG. 7 is an exemplary flowchart showing a network connection blocking release procedure in an IoT infrastructure.

FIGS. 8A and 8B are views for describing a priority of determining a device to be released according to a network connection blocking release policy.

FIGS. 9A to 9C illustrate examples of a security control policy.

FIG. 10 illustrates an example of a security control message format.

### DETAILED DESCRIPTION OF EXEMPLARY EMBODIMENTS

Hereinafter, aspects for implementing the present invention will be described with reference to the following embodiments. The present invention is not limited to such embodiments, and the present invention may be embodied in various forms within the scope of the technical spirit of the present invention. The terminology used herein is for the purpose of describing particular embodiments only and is not intended to be limiting to the invention. As used herein, the singular forms “a,” “an,” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

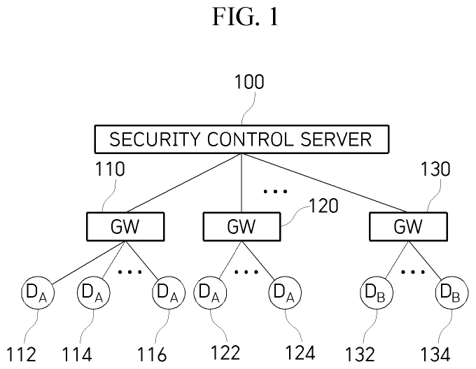

FIG. 1 schematically illustrates a system for security control for an Internet of Things (IoT) infrastructure according to an embodiment of the present invention.

In a general IoT infrastructure environment, various IoT devices are connected to various service providing servers through wired/wireless communication via gateways. Referring to FIG. 1, the present embodiment includes a security control server 10 configured to generate a security control message, such as a network connection blocking command and a network connection blocking release message for various IoT devices D_{A} and D_{B} (112, 114, 116, 122, 124, 132, and 134) and includes gateways GW (110, 120, and 130) configured to receive the security control message from the security control server 10 and perform security control on a device (devices) targeted for control.

The security control server 10 may be located in a management server that manages various policies on IoT services. The gateway is a device for managing a network connection of devices that are installed and operated in an actual field for IoT services and may be configured in a variety of scales according to the IoT service.

The security control server 100 monitors security control statuses of the various IoT devices 112, 114, 116, 122, 124, 132, and 134 included in the IoT environment by communicating with the gateways 110, 120, and 130 and manages the security control of the devices 112, 114, 116, 122, 124, 132, and 134. The devices 112, 114, 116, 122, 124, 132, and 134 perform information collection, service control, and the like for IoT services and may include various sensors, for example, a temperature and humidity sensor, a pressure sensor, a speed sensor, a geomagnetic sensor, an optical sensor, a motion sensor, and the like, and an actuator, a power module, a communication module, a robot, a terminal, a smart phone, and a computing device.

Each device may belong to at least one device group. When a security threat occurs on a specific device, a security control message is generated to control the device in which the security threat is expected, so that the device is basically controlled, for example, regardless of the magnitude and frequency of the threat occurrence. However, in case that the degree of security threat exceeds the predetermined threshold, a security control message is generated to control a group of similar devices that may be affected by the security threat, including the device where the security threat has occurred.

In the above, the device group includes at least one device. For example, the device group may be a logical group including at least one device accessible through different gateways. For example, device group A includes the devices D_{A} (112, 114, and 116) accessible through the gateway 110 and the devices D_{A} (122 and 124) accessible through the gateway 120. For another example, the device group may include at least one device accessible through the same gateway. For example, device group B includes the devices D_{B} (132 and 134) accessible through the gateway 130. In addition, the device group may be a group of devices having the same physical location. For example, a device group is a group of devices located in the same building or connected to the same gateway. In addition, the device group may be a group of devices equipped with similar modules or functions in hardware or software. For example, the device group is a group of devices having the same manufacturer, the same device model, or the same year of manufacture. In addition, the device group may be a group of devices subscribed for the same service. In addition, the device group may include only one device. For example, each device belongs to a device group that includes only itself

The gateways 110, 120, and 130 are devices that provide the devices 112, 114, 116, 122, 124, 132, and 134 with connectivity to the outside. That is, the gateways 110, 120, and 130 are gates that communication signals of the various IoT devices 112, 114, 116, 122, 124, 132, and 134 to be connected to the outside via the network need to pass through. In one example, the gateways 110, 120, and 130 execute a security control policy on a device belonging to a device group in which a security threat is detected on the basis of a security control message received from the security control server 100.

The security control server 100, in response to detecting the security threat, transmits the security control message to the gateways 110, 120, and 130 on the basis of the security control policy. For example, the security control message may be a network connection blocking and unblocking command of the IoT device 112, 114, 116, 122, 124, 132, 134. In order to prevent the security threat from spreading, the security control policy determines the target and level of control according to the characteristics of security threats, such as the severity and the magnitude of the security threat having occurred.

The gateways 110, 120, and 130 receive the security control message and perform a task for responding to the security threat on the basis of an instruction of the security control message. In one example, the security control server 100 transmits the security control message to a gateway including a device group in which the security threat is detected. For example, when a security threat is detected in a device 116 among the devices belonging to device group A, the security control server 100 transmits a security control message to the gateway 110 to which the device 116 is connected. In addition, the security control server 100 may transmit a security control message to the gateway 120 to which the devices 122 and 124 belonging to device group A are connected. The gateway 110 and the gateway 120 perform an operation which is instructed according to the received security control message. For example, the gateway 110 may block connection of the devices 112, 114, and 116 belonging to device group A.

In the present embodiment, it is represented that the security control message is distributed to the gateway(s), GW, to which the device is connected in order to block/release device's network connection, but the present invention is not limited thereto. That is, a configuration in which the security control message is directly transmitted to the device without the presence of the GW is possible.

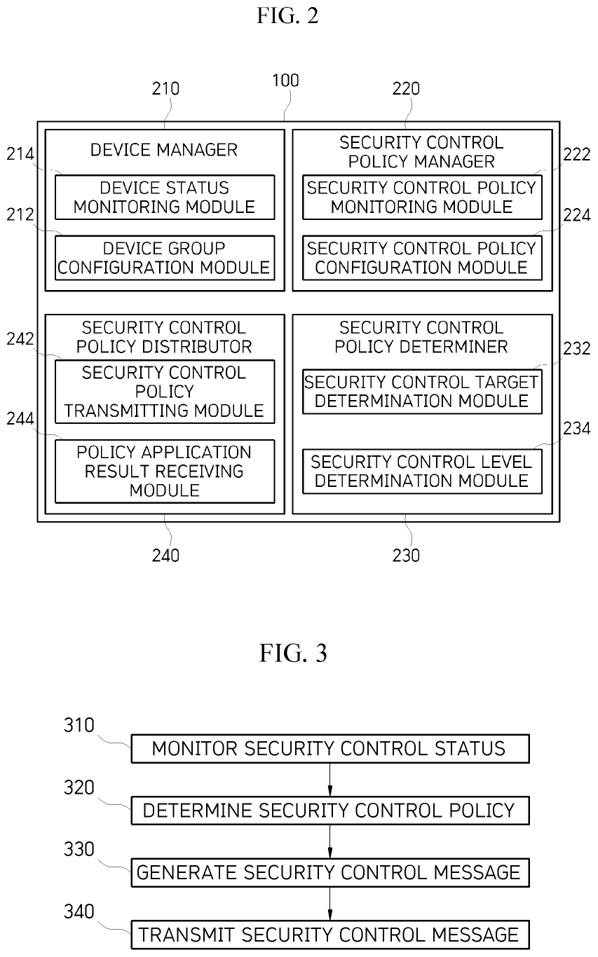

FIG. 2 is a block diagram illustrating the security control server 100 shown in FIG. 1.

The security control server 100 includes a device manager 210, a security control policy manager 220, a security control policy determiner 230, and a security control policy distributor 240. Here, the security control server 100 may be a part included in an IoT server that provides a certain type of service to at least one device or device group.

Although not shown, the security control server 100 includes a storage configured to store device information and a standard security control policy generated with regard to a potential security threat and includes a processor. The processor may be an arithmetic device that performs arithmetic operations according to instructions using data stored in a memory. For example, the processor is implemented using various microprocessors such as a central processing unit (CPU).

Hereinafter, a configuration of the processor of the security control server 100 will be described with reference to FIG. 2.

First, the processor of the security control server 100 is configured to operate the device manager 210 that monitors a security control status for a security threat to at least one device. The device manager 210 includes a device group configuration module 212 and a device status monitoring module 214.

The device group configuration module 212 manages device information, and, to this end, registers the device information in the system and modifies and deletes the device information in the system. In addition, the device group configuration module 212 configures a device group by grouping IoT devices by characteristics and manages device group information by registering the device group information in the system and modifying and deleting the device group information in the system. The device information and the device group information are stored in the storage of the security control server 100.

The device status monitoring module 214 monitors the security control status of each device. In one example, the device status monitoring module 214 determines the security control status of each device on the basis of a response of each device to a security control status inspection, data periodically received from each device, a frequency of gateway accesses of each device, and the like. On the basis of the security control status, the security control policy determiner 230, which will be described below, may determine whether a security threat has occurred.

As a result, the device manager 210 manages the device information and the device group information through the device group configuration module 212 and monitors the security control status of each device through the device status monitoring module 214.

Second, the processor of the security control server 100 is configured to operate the security control policy manager 220 that generates the standard security control policy against the potential security threat. The security control policy manager 220 includes a security control policy monitoring module 222 and a security control policy configuration module 224.

The security control policy configuration module 224 serves to generate, modify, and delete the standard security control policy that defines a content and a target of the security control for security threats that may potentially occur. That is, the security control policy configuration module 224 manages the standard security control policy which is a standard for determining a security control policy in the security control policy determiner 230 which will be described below. The security control policy configuration module 224 stores the standard security control policy in the storage of the security control server 100.

The security control policy monitoring module 222 monitors a result of applying the security control policy. For example, the security control policy monitoring module 222 monitors a result of applying a security control policy that is received from each gateway in response to a security control message transmitted from the security control policy distributor 240, which will be described below, to a device or a device group in which a security threat has occurred.

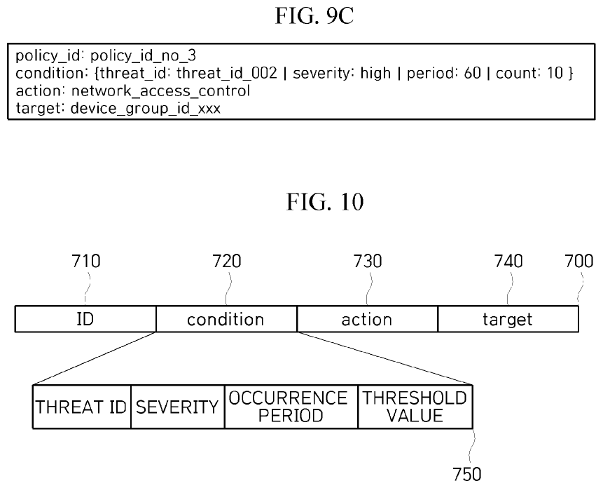

Third, the processor of the security control server 100 is configured to operate the security control policy determiner 230 that determines a security control policy on a device group in which a security threat is expected. The security control policy determiner 230 determines a security control policy on a device group in which a security threat is expected on the basis of the standard security control policy generated by the security control policy manager 220 with regard to a potential security threat. The security control policy determined by the security control policy determiner 230 will be described below with reference to FIGS. 9A-9C and 10. The security control policy determiner 230 includes a security control target determination module 232 and a security control level determination module 234.

The security control target determination module 232 determines a device group to which a security control policy is to be distributed to prevent the security threat from spreading. That is, the security control target determination module 232 determines a device group in which a received security threat is expected to occur or propagate as a device group to which a security control policy is to be distributed. In one example, the device group in which a security threat is expected is a device group including a device that is detected as having the security threat as a result of monitoring by the device manager 210.

The security control level determination module 234 determines the level of control on the device on the basis of the characteristics of the security threat, such as the type and severity of the security threat. For example, the security control level determination module 234 may determine the level of control as device operation control, network packet control, service session control, and blocking and blocking release of connection to an IoT infrastructure on the basis of the characteristics of the security threat.

Among the levels of control, the network connection blocking for preventing a security threat from spreading in an IoT infrastructure and the network connection blocking-release for minimizing a service delay occurring due to the network connection blocking will be described as an example to aid in the understanding of the level of control. In this case, the security control server 100 may include a connection blocking sub module and a connection blocking release sub module, for example, in the security control level determination module 234.

The connection blocking sub module, in response to detecting a security threat in the IoT, determines whether to block only a device in which the security threat has occurred or to collectively block the same device group including the device in which the security threat has occurred or a similar device group (having sameness) depending on the level of the detected security threat and requests a network connection blocking command to a gateway to which the device 30 is connected. The grouping of devices to be blocked may include categorizing devices having physical sameness (e.g., a closed-circuit television (CCTV), a meter reader, a door lock, etc.), service-providing devices having sameness, and/or devices having an operating environment having sameness (e.g., operating system (OS) and version, etc.). In addition, when the detected security threat is determined as a highly contagious DDoS (distributed denial of service) attack or a quickly spreading malicious code, a device group which is to be subject to the network connection blocking is determined according to the spreading or propagation method. For example, in response to detecting a malicious code that is mainly transmitted to a CCTV, a CCTV product or a CCTV product group in which the security threat has occurred is determined as a device group to be subject to the network connection blocking. In this way, the corresponding product, which is highly likely to have the detected security threat spread therein, may be blocked in advance even without detecting the security threat in the corresponding product. On the other hand, the connection blocking release sub module is provided to, when a normal device is subject to a connection blocking as a result of performing the connection blocking on devices in units of groups, rapidly release the connection blocking of the normal device to prevent a service delay due to the connection blocking of the normal device. Because a device, which has not been detected as having the security threat, may be detected as having the security threat in a device inspecting process, the connection blocking release sub module may provide a function for removing the security threat from the device detected as having the security through a recovery. In addition, the connection blocking release sub module may manage the history (the number and the like) of occurrences of the security threat of the device detected as having the security threat so that the history is used as a guide for determining a device to be released from the blocking in a security status inspection of the network connection blocking process.

In this example, the gateway 110, 120, or 130 may serve to block the network connection or release the blocking according to a network connection block or unblock command received from the security control server 100. A detailed method of blocking a network connection of a device and releasing the blocking (for example, using the Iptables firewall feature in Linux) may not need to be additionally described. In addition, the device performs a device security status inspection function through a security status inspection and recovery module configured in the device. The device security status inspection may be performed by measuring integrity values of a booting image, an execution object, and a setting file in the device. In the case of the integrity value measurement, an abnormal behavior, such as an abnormal binary (malicious codes, etc.) installation and a setting change, may be inspected in an environment initially installed and operated. When it is determined in the integrity measurement process that the device has an abnormality, that is, when the device is determined to have an abnormality in response to a mismatch between an integrity value in the initially installed and operated environment and an integrity value measured at the time of inspection, the device is restored to the normal state through a software (SW) image update of the device or the like.

Fourth, the processor of the security control server 100 is configured to operate the security control policy distributor 240 that generates a security control message on the basis of the security control policy determined by the security control policy determiner 230. In addition to generating the security control message, the security control policy distributor 240 serves to transmit the generated security control message that a security threat is expected to a device group determined by the security control policy determiner 230. The security control policy distributor 240 includes a security control policy transmitting module 242 and a policy application result receiving module 244.

The security control policy transmitting module 242 generates a security control message and transmits the security control message to the gateways 110, 120, and 130 that may perform the security control policy included in the security control message on a device concerned. The security control message includes security control policy information and target device group information in which a security threat is expected, which are determined by the security control policy determiner 230. The security control message will be described below with reference to FIG. 10.

The policy application result receiving module 244 receives a result of applying the security control policy and stores the result in the storage. In one example, the result of applying the security control policy may be used for the device manager 210 and the security control policy manager 220 to monitor the security control status of the device or device group.

FIG. 3 is a flowchart showing a method of network security control according to an embodiment of the present invention.

First, the method for security control includes monitoring a security control status for a security threat of at least one device (310).

In operation 310, the security control status for the security threat of each device constituting an IoT environment is monitored. The operation may be performed, for example, by the device status monitoring module 214, for example, of the device manager 210.

Second, the method for security control includes determining a security control policy for a device group in which a security threat is expected (320).

In operation 320, if it is determined as a result of monitoring the security control status in operation 310 that a security threat is detected, a security control policy for a device or device group in which the security threat is expected is generated, for example by the security control policy determiner 230, on the basis of a standard security control policy against the potential security threat generated, for example by the security control policy manager 220.

That is, in operation 320, a target device or device group to which the security control policy is to be distributed is determined, for example, by the security control target determination module 232 of the security control policy determiner 230, to prevent the security threat from spreading. As described above with reference to FIG. 2, the security control target determination module 232 determines a device or device group in which the received security threat is expected to occur or propagate as a target for distribution of the security control policy.

Further, in operation 320, the level of control on the device is determined on the basis of the characteristics of the security threat, such as the type and severity of the security threat, for example, by the security control level determination module 234 of the security control policy determiner 230.

Third, the method for security control includes operation 330 generating a security control message on the basis of the security control policy determined in operation 320.

In operation 330, the security control message is generated, for example, by the security control policy transmitting module 242 of the security control policy distributor 240. The security control message will be described below with reference to FIG. 10.

Fourth, the method for security control includes transmitting the security control message generated in operation 330 to the device or device group in which the security threat is expected (340). In this operation 340, the security control message generated, for example, by the security control policy transmitting module 242 of the security control policy distributor 240, may be transmitted to the gateways 110, 120, and 130 that may perform the security control policy included in the security control message.

In addition, the method for security control according to one embodiment of the present invention may further include generating a security control release message on the basis of the security control policy. The security control release message is a message that releases the security control policy applied to the device or device group, in which the security threat has occurred, through the security control message.

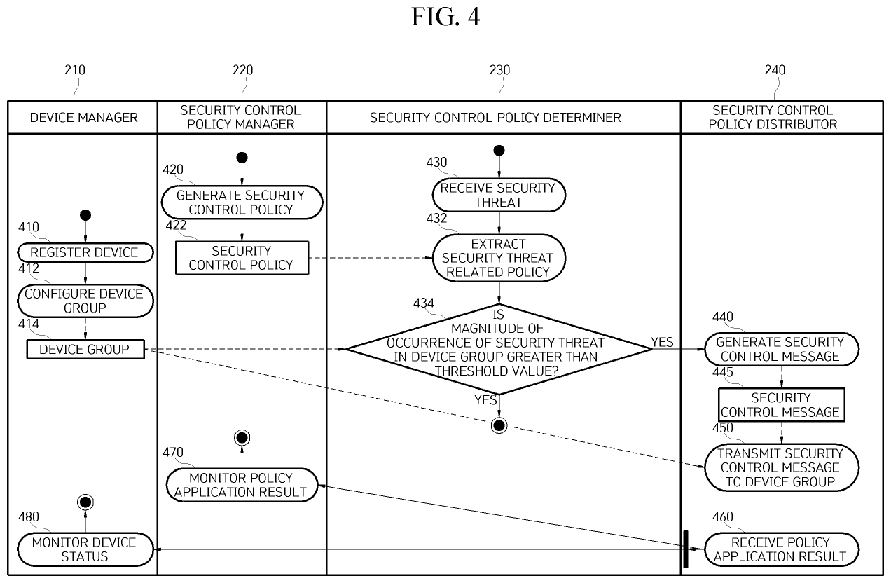

FIG. 4 is a flowchart showing a process of performing network security control by the apparatus for security control shown in FIG. 2 according to the security control process shown in FIG. 3.

In operations 410 and 412, the device manager 210 registers a device and configures a device group 414 through the device group configuration module 214.

The generated device group 414 is used in operation 434 in determining whether to generate a security control message and in operation 450 in transmitting the security control message.

In operation 420, the security control policy manager 220 generates a standard security control policy 422 with regard to a potential security threat by using the security control policy configuration module 224. The generated standard security control policy 422 serves as a standard for the security control policy determiner 230 to determine a security control policy at a time of occurrence of a security threat in operation 432.

In operation 430, the security control policy determiner 230 receives security threat occurrence information. For example, the security control policy determiner 230 receives information about a security threat that has occurred in a specific device as a result of monitoring a device status by the device manager 210.

In operation 432, the security control policy determiner 230 determines a security control policy to cope with the security threat that currently occurs on the basis of the standard security control policy 422 generated by the security control policy manager 220 in operation 422. That is, the security control policy determiner 230 extracts a security policy list related to the corresponding security threat from the standard security control policy and determines a security control policy to be currently executed from the security policy list on the basis of the severity, and the like of the security threat.

In operation 434, the security control policy determiner 230 determines whether the magnitude of occurrence of the security threat in the device group 414 including the device in which the security threat currently occurs is greater than a threshold value by referring to the information about the device group 414. The threshold value may be determined on the basis of the security control policy generated in operation 432.

In operation 440, the security control policy distributor 240 generates a security control message 445 on the basis of the corresponding security control policy when the magnitude of the security threat identified in operation 434 is greater than the threshold value determined according to the security control policy.

In operation 450, the security control policy transmitting module 242 of the security control policy distributor 240 transmits the security control message 445 to the corresponding device group by referring to the information about the device group 414.

In operation 460, the policy application result receiving module 244 of the security control policy distributor 240 receives a result of applying the security control policy included in the security control message 445.

In operation 470, the security control policy manager 220 monitors the policy application result received in operation 460.

In operation 480, the device manager 210 monitors a security control status of each device through the device status monitoring module 214 on the basis of the policy application result received in operation 460.

In operations 470 and 480, whether the security control is properly performed is monitored and whether additional control is required on the basis of the result of applying the control policy is determined.

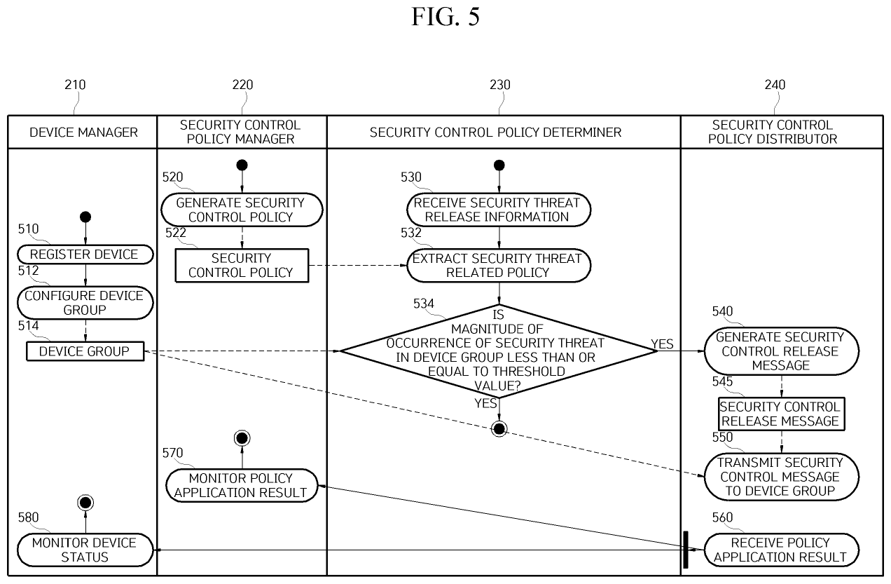

FIG. 5 is a flowchart showing a process of performing a network security control release according to the security control process shown in FIG. 3 by the apparatus for security control shown in FIG. 2.

In operations 510 and 520, the device manager 210 registers a device and configures a device group 514 through the device group configuration module 214.

The generated device group 514 is used in operation 534 in determining whether to generate a security control release message and in operation 550 in transmitting the security control release message.

In operation 520, the security control policy manager 220 generates a standard security control policy 522 with regard to a potential security threat through the security control policy configuration module 224. The generated standard security control policy 522 serves as a standard for the security control policy determiner 230 to determine a security control policy upon receiving security threat release information in operation 532.

In operation 530, the security control policy determiner 230 receives the security threat release information. For example, the security control policy determiner 230 receives security control status information indicating that a security threat which has occurred in a specific device has been released or resolved as a result of monitoring a device status by the device manager 210.

In operation 532, the security control policy determiner 230 determines a security control policy for responding to the security threat release on the basis of the standard security control policy 522 generated by the security control policy manager 220 in operation 522. For example, the security control policy determiner 230 may extract a security policy list related to the corresponding security threat from the standard security control policy and determine a security control policy for releasing the corresponding security policy.

In operation 534, the security control policy determiner 230 determines whether the magnitude of the security threat having occurred in the device group 514 including the device in which the security threat currently occurs is less than or equal to a threshold value by referring to the information about the device group 514. The threshold value may be determined on the basis of the security control policy generated in operation 532.

In operation 540, the security control policy distributor 240 generates a security control release message 545 on the basis of the corresponding security control policy when the occurrence magnitude of the security threat identified in operation 534 is less than or equal to the threshold value determined according to the security control policy.

In operation 550, the security control policy transmitting module 242 of the security control policy distributor 240 transmits the security control release message 545 to the corresponding device group 514 by referring to the information about the device group 514.

In operation 560, the policy application result receiving module 244 of the security control policy distributor 240 receives a result of applying the security control policy included in the security control release message 545.

In operation 570, the security control policy manager 220 monitors the policy application result received in operation 560.

In operation 580, the device manager 210 monitors a security control status of each device through the device status monitoring module 214 on the basis of the policy application result received in operation 560.

In operations 570 and 580, it is identified whether the release has been properly performed by monitoring the result of applying the control release policy.

Hereinafter, a case of blocking network connection of a device group and a case of releasing the blocking will be described as an example of the security control and the security control release to aid in the understanding of the security control and security control release.

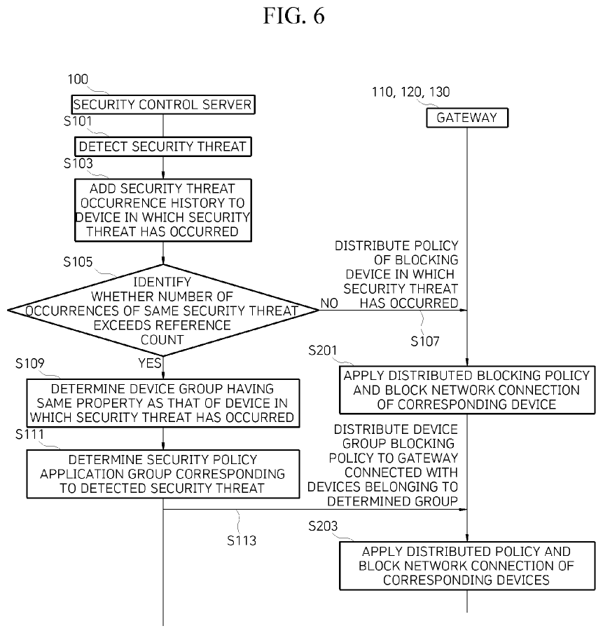

FIG. 6 is an exemplary flowchart showing a procedure of operations of blocking device connection to a network (e.g., IoT) by the security control server 100 shown in FIG. 1.

S101: The security control server 100 detects a security threat. The detection of security threat is performed using various security threat detection methods, and the present invention does not limit the detection method.

S103: A history indicating an occurrence of the security threat is added for a device in which the security threat has been detected. For example, the number of times the security threats have occurred is accumulated. The security threat occurrence history information is used for the order in which a device to be released is determined when releasing the network connection blocking of the device.

S105: Whether the detected security threat has repeatedly occurred more than a reference count set by an administrator is checked. Here, the reference count refers to a reference value based on which the devices are blocked in units of groups. The number of instances of duplicate occurrences applies to a plurality of devices in a service area of management. The occurrences exceeding the reference count represents that the security threat has been propagated to a plurality of devices, and that not only a device in which the security threat has occurred but also the same or similar device as a device to which the security threat has been propagated need to be blocked in advance. The device group may be defined in several ways, such as using the same model, using the same operating system and version, and providing the same service, without limitation.

S107: When the threshold value for blocking a group is not exceeded, a policy of blocking a pertinent device (the device in which the security threat has occurred) is distributed to the gateway to which the device is connected.

S201: The gateway blocks network connection of the corresponding device by applying the blocking policy distributed from the security control server 100.

S109: When it is determined as a result of checking in operation S105 that the reference value (or threshold value) for blocking a device group is exceeded, a device group having the same property as that of the device in which the security threat has occurred is determined.

S111: In addition, a device group corresponding to a blocking policy separately defined by the administrator according to the detected security threat is identified.

S113: The network connection blocking policy of the device is distributed to the gateway connected with devices belonging to the determined device group as a result of determining the device group.

S203: The gateway applies the blocking policy distributed from the security control server 100 to collectively block the network connection of the corresponding devices.

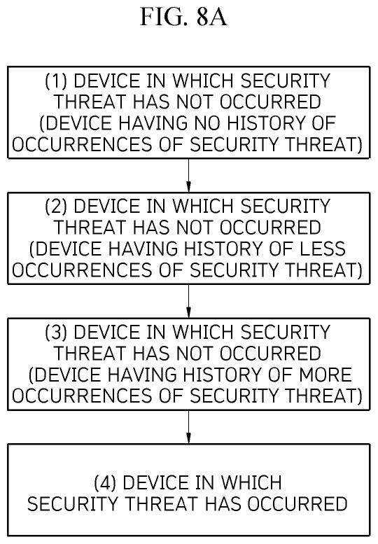

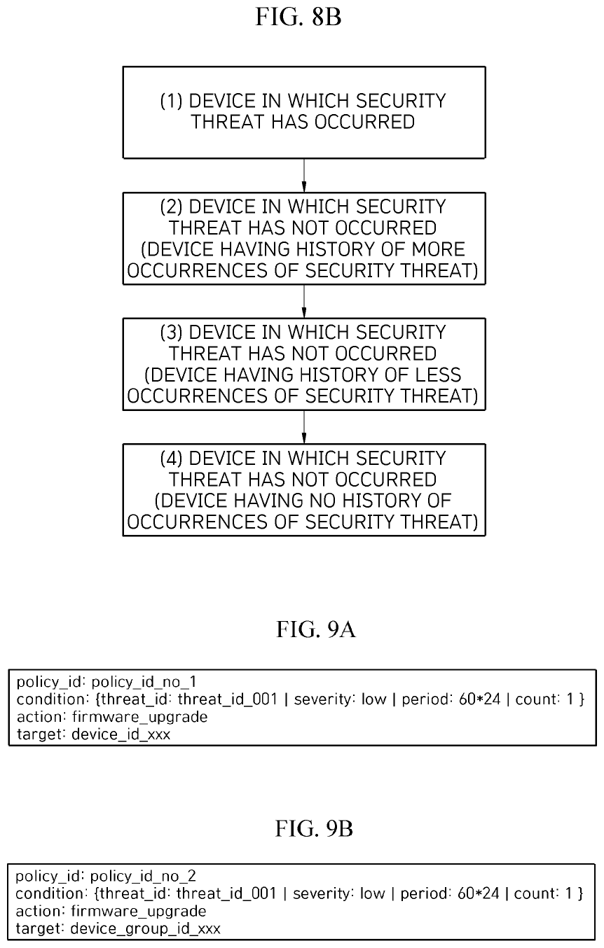

FIGS. 8A and 8B are views for describing a priority of determining a device to be released according to a network connection blocking release policy.

The order in which the device is to be released from the network connection may vary depending on whether the service provisioning is prioritized, or the security management is prioritized and may conform to a policy of a site providing the network service.

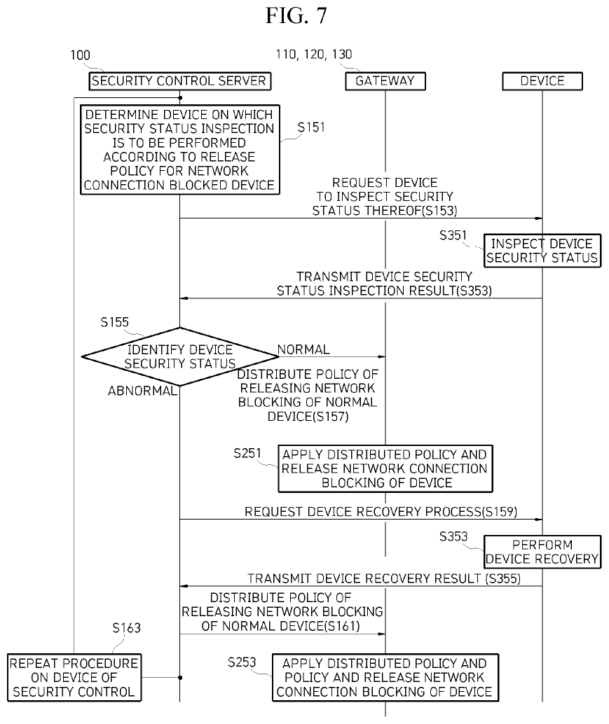

FIG. 7 is a flowchart showing a procedure of operations of releasing connection blocking of devices in a device group for rapid service resumption after a network connection blocking is applied to the device group in an IoT infrastructure.

S151: The security control server 100 determines a device on which a security status inspection is to be performed according to a blocking release policy (see FIGS. 8A and 8B and related descriptions below) for a device (devices), in which a network connection is blocked, adopted by a service.

S153: The security control server 100 requests the determined device to inspect the security status thereof

S351: The device requested to inspect the security status generates its own security status inspection result value through an integrity measurement or the like.

S353: The device transmits the security status inspection result value thereof to the security control server 100.

S155: The security control server 100 identifies the security status inspection result value transmitted by the device to determine whether the device is normal or abnormal.

S157: When the device is determined to be normal, the security control server 100 transmits a policy of releasing the network connection blocking of the device to the gateway connected to the device.

S251: The gateway applies the received policy to release the network connection blocking of the device and allows the service to be resumed.

S159: When it is determined as a result of inspecting the security status of the device in operation S155 that the device is abnormal, the security control server 100 requests the recovery process of the device.

S353: The device performs the recovery process to restore the normal state according to the request for recovery. The recovery process may be performed through a software update or the like.

S355: The device transmits the recovery result to the security control server 100.

S161: The security control server 100 transmits a network connection blocking release policy to the gateway to which the device is connected to resume the service of the recovered device.

S253: The gateway applies the received policy to release the network connection blocking of the device and allows the service to be resumed.

S163: The security control server 100 repeats the above procedure on a device to be released next according to the policy described in FIGS. 8A and 8B.

According to embodiments, the process of determining a device to be released from the network connection blocking and the process of releasing the determined device may be performed sequentially or may be performed in parallel to increase the performance.

FIGS. 8A and 8B are views for describing a priority of determining a device to be released according to a network connection blocking release policy.

FIG. 8A illustrates a policy of determining a device to be released from network connection blocking by applying a service providing priority policy. Assume a normal device even without having the security threat due to a possibility of potentially having the security threat was blocked because of having the same property as a device in which a security threat had occurred to prevent the security threat from spreading. However, the blocked device needs to be preferentially inspected for the security status to be released from the network connection blocking to rapidly resume the service because the normal device blocked without the security threat may actually have no security threat. In addition, the normal device without the security threat is highly likely to be a device in which the security threat has not occurred, and a device having a history of a small number of occurrences of the security threat among devices without the security threat is more likely to be a normal device.

Accordingly, as shown in FIG. 8A, the network connection blocking is released by performing the security status inspection starting from (1) a device having no history of occurrences of a security threat among devices in which the security threat has not occurred. After that, the network connection blocking is released by performing the security status inspection in the order of (2) a device having a history of a small number of occurrences of the security threat among devices in which the security threat has not occurred, and (3) the device having a history of a large number of occurrences of the security threat among the devices in which the security threat has occurred. (4) The device in which the security threat has occurred always requires a device security status recovery and thus is subject to the network connection blocking release procedure regardless of the order.

FIG. 8B illustrates a case of determining a device to be released from network connection blocking by applying a security threat management priority policy. In other words, this is a case where security threat processing is prioritized over service provision and may be applied when a site that operates in an IoT service adopts a high-level security policy. In this case, (1) a device in which a security threat has occurred is given the highest urgency for processing the security threat, and thus the device is first subject to the recovery and release procedure. After processing the device in which the security threat has occurred, devices in which the security threat has not occurred are processed by inspecting the security status of the devices and releasing the network connection blocking in the order of (2) a device having a history of a large number of occurrences of the security threat, (3) a device having a history of a small number of occurrences of the security threat, and (4) a device in which the security threat has not occurred in consideration that a device having a history of a large number of occurrences of the security threat is highly like to include the security threat.

FIGS. 9A to 9C illustrate examples of the security control policy described above.

The security control policy may include one selected from a group of information about an identifier of the security control policy (policy_id), a condition for applying the security control policy (condition), an action according to the security control policy (action), and a target of the security control policy (target). As a matter of course, the security control policy may include all of the above information.

The condition includes, for example, an identifier of a security threat (threat_id), the degree to which the security threat is severe (severity), a period for which the security threat has occurred (period), and the number of times the security threat has occurred (count). On the basis of the condition, the threshold of the magnitude of a threat occurrence described in operations 434 and 534 may be determined. For example, the threshold of the magnitude of a threat occurrence in operations 434 and 534 may be determined on the basis of at least one of the severities, the period, and the count.

FIG. 9A is an exemplary security control policy (policy_id_no_1) and shows a security control policy, in response to detecting a vulnerability (threat_id_001) having a low possibility of a security threat spreading (severity: low) from a device (device_id_xxx), for removing the vulnerability through firmware upgrade (firmware_upgrade) of the device, and the like. In this case, the target is a device group including a single device (device_id_xxx).

FIG. 9B is an exemplary security control policy (policy_id_no_2) and shows a security control policy, in response to determining that a vulnerability (threat_id_001) is highly likely to exist in a specific device model, for instructing a device group (device_group_id_xxx) including devices of the same model to perform firmware upgrade (firmware_upgrade).

FIG. 9C is an exemplary security control policy (policy_id_no_3), which shows an example of a security control policy defined such that even the same security threat is controlled with different targets and levels according to the severity or the magnitude of the security threat. For example, when a malicious code (threat_id_002) is detected in one device, the policy may be configured to perform network access control (network_access_control) only on the device, and when the same malicious code (threat_id_002) is detected in multiple devices in one device group, the policy may be configured to perform network access control (network_access_control) on the entire device group (device_group_id_xxx).

FIG. 10 illustrates an exemplary format of the security control message described above.

The security control policy distributor 240 generates a security control message or a security control release message. The security control message or the security control release message includes, for example, an identifier of a security control policy, that is, a security control policy ID 710, a security control condition 720, a security control action 730, and target information 740. Referring to FIG. 10, the security control policy ID 710 corresponds to policy_id, the security control condition 720 corresponds to condition, the security control action 730 corresponds to action, and the target information 740 corresponds to target.

The security control policy 710 determines the target and level of the control according to the characteristics of the security threat, such as the severity and the magnitude of the security threat, to prevent the security threat from spreading. To this end, the security control condition policy may include a security threat identifier, a severity, a magnitude of a security threat having occurred, a target to be controlled and a level of control, and a method of control.

The security control condition 720 refers to a condition for performing a security control action and may include a severity of a security threat, a period of occurrence of a security threat, and a number of times a security threat has occurred.

The security control action 730 refers to the method and level of security control according to the security threat. For example, the security control action 730 includes device operation control, network connection control, service session control, and the like.

The target information 740 refers to a device group to which the security control message is to be distributed. For example, the target may include a device group to which a device belongs in which a security threat has occurred, or a device group in which a security threat is highly likely to spread.

The security control server 100, as described with reference to FIG. 4, generates a security control message according to the security level and method defined by the security control action 730 when the magnitude of the security threat having occurred in a device group exceeds a threshold defined by the security control condition 720, selects a device group to which the security control policy is to be distributed by referring to the target of control defined by the target information 740, which is a target of security control, and transmits the security control message including the security control policy to the corresponding device group.

The apparatus and method for security control according to the embodiment of the present invention may be implemented in a computer system or may be recorded on a recording medium. The computer system may include at least one processor, a memory, a user input device, a data communication bus, a user output device, and a storage. The above described components perform data communication through the data communication bus.

The computer system may further include a network interface coupled to a network. The processor may be a central processing unit (CPU) or a semiconductor device for processing instructions stored in the memory and/or storage.

The computer system may be, for example, a single server computer or a system similar to the server computer or may be a plurality of servers arranged in one or more server banks or other arrangements. For example, the computer system may be a distributed processing system or parallel processing system based on a plurality of processors, a clustering server group, or a cloud server. Computer systems, such as servers or server groups, may be located in a single facility or may be distributed among a number of different geographical locations. Each server may include a processor, a communication interface, and a memory. The processor, the memory and the communication interface may be connected to each other through a communication bus.

The memory and the storage may include various forms of volatile or nonvolatile media. For example, the memory may include a read only memory (ROM) or a random-access memory (RAM).

The method for security control according to the embodiments of the present invention may be implemented in a form executable by a computer. When the method for security control according to the embodiments of the present invention is performed by the computer, instructions readable by the computer may perform the method for security control according to the present invention.

The method for security control according to the present invention may be embodied as computer readable codes on a computer-readable recording medium. The computer-readable recording medium is any recording medium that can store data that can be read thereafter by a computer system. Examples of the computer-readable recording medium include a ROM, a RAM, a magnetic tape, a magnetic disk, a flash memory, an optical data storage, and the like. In addition, the computer-readable recording medium may be distributed over network-connected computer systems so that computer readable codes may be stored and executed in a distributed manner.

As is apparent from the above, the present invention provides a security control policy that can be flexibly formed to have various targets and levels according to the characteristics of a network security threat, such as the type, the severity, and the magnitude of the network security threat having occurred.

In addition, the present invention can minimize a security threat from spreading in a network infrastructure, such as IoT, and the like by controlling a device highly likely to spread the threat in advance according to a security control policy that is previously defined to cope with a detected security threat.

As a function of the apparatus and method for security control according to the present invention, a network connection blocking function collectively blocks a device in which a security threat has occurred and a device in which the same security threat is highly likely to occur in advance so that a security threat can be blocked from spreading from a device in which a security threat has not found, thereby proactively preventing damage to network infrastructures and services that may be caused by DDoS attacks or other highly contagious malicious codes.

In addition, as a function of the apparatus and method for security control according to the present invention, a network connection blocking release function can minimize service delay that can occur due to network connection blocking of devices. Considering that a normal device having no security threat can be blocked when the network connection blocking is applied in units of device groups each having a similar property, the network connection blocking release function is performed by continually inspecting the security status of the device in which the network connection is blocked.

As such, the service delay can be minimized while preventing the spread of security threats to the network infrastructure without administrator intervention.

Information technology (IT) market researcher Gartner predicts that the number of IoT-related connected devices which amount to 5 billion in 2015 will reach 25 billion by 2020, and with the increasing number of electronic devices and objects affected by IoT, the number of objects used in connection with the Internet will increase from 10 billion in 2014 to 30 billion in 2020. The UK's Machina Research estimates a growth of the global IoT market to $1.2 trillion by 2022 with an average annual growth rate of 218%. As the size of the IoT grows, the damage caused by security incidents is expected to increase, and the size of IoT security damages due to hacking and the like is expected to increase from 134 trillion KW (Korean Won) in 2015 to 267 trillion KW in 2030 (KIET, 2014) such that the demand for security technology is increased while expanding the related markets.

In addition, IoT-based large-scale services are spreading to specific services, such as smart remote meter reading services of power/gas/water, smart healthcare services, and the like, and due to the public interest and the sensitiveness to private information, the services can have a great influence economically and socially when damaged by security threats. Therefore, it is expected that the demand for security technology to solve the issues will increase and the related markets will rapidly expand.

Although the present invention has been described with reference to the embodiments, a person of ordinary skill in the art should appreciate that various modifications, equivalents, and other embodiments are possible without departing from the scope and sprit of the present invention. Therefore, the embodiments disclosed above should be construed as being illustrative rather than limiting the present invention. The scope of the present invention is not defined by the above embodiments but by the appended claims of the present invention, and the present invention is to cover all modifications, equivalents, and alternatives falling within the spirit and scope of the present invention.

What is claimed is:

1. An apparatus for security control in a network infrastructure including at least one device, the apparatus comprising:
a storage configured to store device information and a standard security control policy generated with regard to a security threat; and a processor, wherein the processor is configured to operate:
a security control policy determiner configured to determine a policy of security control on a device in which a security threat is expected; and
a security control policy distributor configured to generate a security control message on the basis of the determined policy of security control and transmit the generated security control message to the device in which the security threat is expected.

2. The apparatus of claim 1, wherein the security control policy determiner comprises:
a connection blocking sub module configured, in response to detecting an occurrence of a security threat to the device in the network infrastructure, to determine a policy of blocking a network connection of the device; and
a connection blocking release sub module configured to determine a policy of network connection blocking release on the device to be released from the connection blocking.

3. The apparatus of claim 1, wherein the security control policy determiner is further configured to determine a policy of security control release on the device in which the security control has been executed,
wherein, when determining the device to be released from the security control, the security control policy determiner determines the device to be released from connection blocking in an order of (1) the device having a history of no occurrence of a security threat among the devices in which the security threat has not occurred, (2) the device having a history of a small number of occurrences of the security threat among the devices in which the security threat has not occurred, (3) the device having a history of a large number of occurrences of the security threat among the devices in which the security threat has not occurred, and (4) the device in which the security threat has occurred.

4. The apparatus of claim 1, wherein the security control policy determiner is further configured to determine a policy of security control release on the device in which the security control has been executed,
wherein, when determining the device to be released from the security control, the security control policy determiner determines the device to be released from connection blocking in an order of (1) the device in which a security threat has occurred, (2) the device having a history of a large number of occurrences of the security threat among the devices in which the security threat has not occurred, (3) the device having a history of a small number of occurrences of the security threat among the devices in which the security threat has not occurred, and (4) the device having no history of occurrences of the security threat among the devices in which the security threat has not occurred.

5. The apparatus of claim 1, wherein the device comprises a security status inspection and recovery module configured to inspect a security status of the device and recover the device to have a normal status when the security status is determined to be an abnormal status.

6. The apparatus of claim 5, wherein the security status inspection and recovery module of the device inspects the security status by measuring integrity values of a booting image, an execution object, and a setting file in the device.

7. The apparatus of claim 1, further comprising a gateway configured to control the device and release the control of the device by receiving the security control message and a security control release message from a security control server.

8. The apparatus of claim 1, wherein the processor is configured to operate a device manager that monitors a security control status for the security threat to the at least one device.

9. The apparatus of claim 1, wherein the processor is further configured to operate a security control policy manager that generates the standard security control policy for the potential security threat.

10. The apparatus of claim 1, wherein the security control message comprises at least one of a security control policy identification (ID), a security control condition, a security control action, and target information.

11. The apparatus of claim 1, wherein the security control policy distributor further configured to generates, when a magnitude of security threat occurrence is greater than or equal to a threshold value predetermined by the policy of security control, a security control message that is to be transmitted to a device group which may be affected by the generated security threat, including the device in which the security threat is expected.

12. A method for security control in a network infrastructure comprising at least one device, the method comprising:
determining a policy of security control on the device in which a security threat is expected; and
generating a security control message on the basis of the determined policy of security control and transmitting the generated security control message to the device in which the security threat is expected.

13. The method of claim 12, wherein the determining of the policy of security policy comprises:
a connection blocking determining sub-operation for, in response to detecting an occurrence of a security threat to the device in an Internet of Things (IoT) infrastructure, determining a policy of blocking an IoT network connection of the device; and
a connection blocking release determining sub-operation for determining a policy of network connection blocking release on the device to be released from the connection blocking.

14. The method of claim 12, wherein the determining of the policy of security control comprises determining a policy of security control release on the device in which the security control has been executed,
wherein, when determining the device to be released from the security control, the device to be released from connection blocking is determined in an order of (1) the device having a history of no occurrence of a security threat among the devices in which the security threat has not occurred, (2) the device having a history of a small number of occurrences of the security threat among the devices in which the security threat has not occurred, (3) the device having a history of a large number of occurrences of the security threat among the devices in which the security threat has not occurred, and (4) the device in which the security threat has occurred.

15. The method of claim 12, wherein the determining of the policy of security control comprises determining a policy of security control release on the device in which the security control has been executed,
wherein, when determining the device to be released from the security control, the device to be released from connection blocking is determined in an order of (1) the device in which a security threat has occurred, (2) the device having a history of a large number of occurrences of the security threat among the devices in which the security threat has not occurred, (3) the device having a history of a small number of occurrences of the security threat among the devices in which the security threat has not occurred, and (4) the device having no history of occurrences of the security threat among the devices in which the security threat has not occurred.

16. The method of claim 12, further comprising
monitoring a security control status for the security threat to the at least one device.

17. The method of claim 12, wherein the determining of the policy of security control comprises
determining a policy of security on the device in which the security threat is expected on the basis of a standard security control policy generated with regard to a potential security threat.

18. The method of claim 12, wherein the determining of the policy of security control comprises
determining a target for security control with respect to the device in which the security threat is expected; and
determining a level of security control in response to the security threat.

19. The method of claim 12, wherein the generating of the security control message further comprises
generating, when a magnitude of security threat occurrence is greater than or equal to a threshold value predetermined by the policy of security control, a security control message that is to be transmitted to a device group which may be affected by the generated security threat, including the device in which the security threat is expected,

20. The method of claim 12, further comprising generating a security control release message on the basis of the policy of security control,
wherein the generating of the security control release message comprises generating the security control release message when a magnitude of security threat occurrence is less than or equal to a threshold value determined by the policy of security control.
